(19) United States
(12) Patent Application Publication
(10) Pub. No.: US 2009/0046317 A1
(43) Pub. Date: Feb. 19, 2009

(54) IMAGE FORMING APPARATUS AND ENVIRONMENT INFORMATION SETTING METHOD THEREOF

(75) Inventor: Wan-su YOO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/185,869

(22) Filed: Aug. 5, 2008

(30) Foreign Application Priority Data
Aug. 17, 2007 (KR) 2007-83043

(51) Int. Cl. G06F 3/12

(52) U.S. Cl. 358/1.15

(57) ABSTRACT

An image forming apparatus and a environment information setting method includes a scanning unit to scan a document to generate image data, a communication unit to access a network, and a controller to control the communication unit to retrieve information on a country in which the image forming apparatus is used when the communication unit accesses the network, and to set the environment information of the communication unit according to the country corresponding to the retrieved country information.

### CROSS-REFERENCE TO RELATED APPLICATIONS

This application claims priority under 35 U.S.C. §119(a) from Korean Patent Application No. 10-2007-0083043, filed on Aug. 17, 2007, in the Korean Intellectual Property Office, the disclosure of which is incorporated herein in its entirety by reference.

### BACKGROUND OF THE INVENTION

1. Field of the Invention

The present general inventive concept relates to an image forming apparatus and an environment information setting method thereof, and more particularly, to an image forming apparatus which sets environment information based on an IP (internet protocol) address retrieved through a network, and an environment information setting method thereof.

2. Description of the Related Art

In general an image forming apparatus such as a printer, a facsimile, a multifunction peripheral, etc., needs to follow a procedure of setting environment information about a primary printing medium, data transmission, a time format, or the like. The environment information is often varied according to which country the image forming apparatus is installed.

Conventionally, a country in which the image forming apparatus is used is determined and environment information suitable for the country is pre-set, during a manufacturing process of the image forming apparatus. That is, a manufacturer should individually set the environment information of the image forming apparatus for every country, which takes a lot of time to manufacture the image forming apparatus and thereby lowers production efficiency.

Further, if the image forming apparatuses having environment information about different countries are mixed by mistake during the manufacturing process, the image forming apparatus may not operate properly and thereby cause inconvenience to a user.

### SUMMARY OF THE INVENTION

The present general inventive concept provides an image forming apparatus to set an environment information on the basis of information corresponding to country received when being used by a user without being set by a manufacturer during a manufacturing process, and an environment information setting method thereof.

Additional aspects and/or utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an environment information setting method of an image forming apparatus, the environment information setting method including connecting the image forming apparatus to a network, setting an IP (internet protocol) address of the image forming apparatus, retrieving information on a country in which the image forming apparatus is used through the network, and setting environment information of the image forming apparatus corresponding to the retrieved country information.

The country information may include an IP address.

The image forming apparatus may include a storage unit to store a country IP address list therein.

The environment information setting method may further include comparing the retrieved IP address with the country IP address list and determining the country corresponding to the IP address.

The retrieving the country information may include retrieving information on a region in which the image forming apparatus is used.

The environment information setting method may further include storing the retrieved country information and the country corresponding to the retrieved country information.

The environment information includes at least one of a display language, a primary printing medium, and a time format.

The environment information may further include a communication standard.

The retrieving the IP address of the country may include tracing a route.

The setting the environment information may include setting the environment information of the image forming apparatus according to the country corresponding to the IP address retrieved by the route tracing.

The environment information setting method may further include displaying at least one of the IP address retrieved by the route tracing and the set environment information.

The setting the IP address of the image forming apparatus may include setting the IP address through a DHCP (dynamic host configuration protocol) server.

The setting the IP address of the image forming apparatus may include setting the IP address by a user's input.

The environment information setting method may further include transmitting and receiving fax data under the communication standard.

The environment information setting method may further include printing the received fax data on a printing medium.

The foregoing and/or other aspects and utilities of the present general inventive concept can also be achieved by providing an image forming apparatus including a communication unit to access a network, and a controller to control the communication unit to retrieve information on a country in which the image forming apparatus is used when the communication unit accesses the network, and sets the environment information of the communication unit according to the country corresponding to the retrieved country information.

The image forming apparatus may further include a scanning unit to scan a document to generate image data, wherein the communication unit includes a modem to modulate and demodulate the image data and to transmit and to receive the image data, and a LAN card which receives the information on the country in which the image forming apparatus is used.

The country information may include an IP address.

The image forming apparatus may further include a storage unit to store a country IP address list and a country environment information list, wherein the controller compares the IP address received through the LAN card with the country IP address list to determine the country corresponding to the IP address.

The environment information may include at least one of a communication standard, a display language, a standard printing medium and time.

The controller may control the display unit to display information with the display language corresponding to the country.

The foregoing and/or other aspects and utilities of the general inventive concept may also be achieved by providing an image forming apparatus comprising a communication unit to access a network, and a controller to control the communication unit to retrieve information based on one or more characteristics of the image forming apparatus, and to set an environment information of the communication unit according to the retrieved information.

The one or more characteristics may comprise a country where the image forming apparatus is being used.

The foregoing and/or other aspects and utilities of the general inventive concept may also be achieved by providing an image forming apparatus comprising a communication unit to access a network, a storage unit to store a country IP address list, and a controller to control the communication unit to retrieve an internet protocol (IP) address of the image forming apparatus through the network, to determine a respective country corresponding to the retrieved IP address by a comparison of the retrieved IP address with the stored country IP address list, and to set an environment information of the communication unit based on the determined country.

The foregoing and/or other aspects and utilities of the general inventive concept may also be achieved by providing a method of setting an environment information in an image forming apparatus, the method comprising accessing a network through a communication unit of the image forming apparatus, controlling the communication unit to retrieve information based on one or more characteristics of the image forming apparatus, and setting an environment information of the communication unit according to the retrieved information.

The foregoing and/or other aspects and utilities of the general inventive concept may also be achieved by providing a method of setting an environment information in an image forming apparatus, the method comprising accessing a network through a communication unit of the image forming apparatus, controlling the communication unit to retrieve an internet protocol (IP) address of the image forming apparatus through the network to determine a respective country corresponding to the retrieved IP address by a comparison of the retrieved IP address with a country IP address list, and setting an environment information of the communication unit based on the determined country.

The foregoing and/or other aspects and utilities of the general inventive concept may also be achieved by providing a computer-readable recording medium having embodied thereon a computer program to execute a method, wherein the method comprises accessing a network through a communication unit of an image forming apparatus, controlling the communication unit to retrieve information based on one or more characteristics of the image forming apparatus, and setting an environment information of the communication unit according to the retrieved information.

### BRIEF DESCRIPTION OF THE DRAWINGS

The above and/or other aspects and utilities of the present general inventive concept will become apparent and more readily appreciated from the following description of the embodiments, taken in conjunction with the accompanying drawings of which:

FIG. 1 is a block diagram illustrating an image forming apparatus according to an exemplary embodiment of the present general inventive concept;

FIG. 2 illustrates an example of a country IP address list;

FIG. 3 illustrates an example of a country environment information list;

FIG. 4 illustrates an example of retrieving an IP address; and

FIG. 5 is a flowchart to describe an environment information setting method of the image forming apparatus according to the exemplary embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

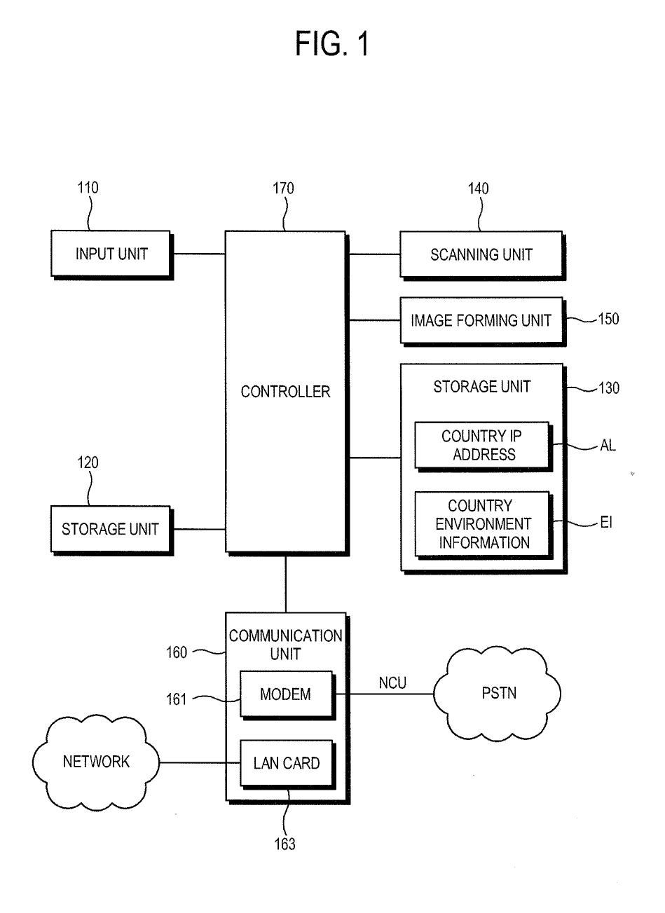

FIG. 1 is a schematic block diagram illustrating an image forming apparatus 100 according to an exemplary embodiment of the present general inventive concept. The image forming apparatus 100 may be achieved by a printer, a copying machine, a facsimile, a multifunction peripheral having two or more functions, etc., which can be connected to a network. Here, the multifunction peripheral may have two or more functions among printing, facsimileing, scanning, copying, etc. As illustrated therein, the image forming apparatus 100 includes an input unit 110 to receive an input from a user, a display unit 120 to display operations of the image forming apparatus 100, a storage unit 130 to store data therein, a scanning unit 140 to scan documents and to generate image data, an image forming unit 150 to output the image data to a printing medium, a communication unit 160 which receives an IP address, and a controller 170 which sets an environment information corresponding to the IP address received by the communication unit 160.

The input unit 110 receives an input from a user. The input unit 110 may include a function key to select functions such as printing, faxing and scanning of the image forming apparatus 100, and a number key to input a fax number if the faxing function is selected. The input unit 110 may receive an optional output command from a user.

The display unit 120 displays operations of the image forming apparatus 100 according to the selected function, and progress rates of transmitting and receiving faxes. The display unit 120 may include a liquid crystal display (LCD) panel to display graphics or texts. The display unit 120 displays information with a predetermined display language, which can be set by the controller 170.

The storage unit 130 stores therein image data generated by the scanning unit 140, and the image data received through the communication unit 160. The storage unit 130, according to the present embodiment, stores a country IP address list (AL) and an environment information list (EL) concerned.

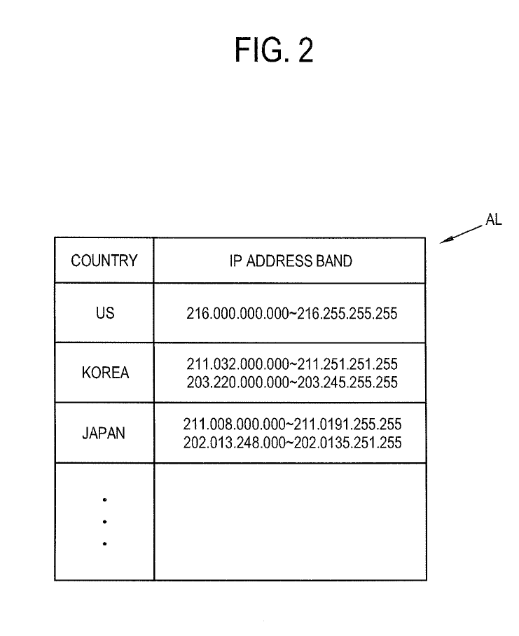

The IP address is an inherent ID (identification) number of the image forming apparatus 100 connected to a network. Each country has IP addresses included in certain bands according to an IP standard. The country AL displays IP address bands for every country. For example, as illustrated in FIG. 2, the U.S. has an IP address band from 216.000.000.000 to 216.255.255.255 while Japan has an IP address band from 202.208.000.000 to 202.255.255.255. The country AL may further include a plurality of bands other than the bands in FIG. 2. With the progress in telecommunication technologies, the country AL may have 16 digits or more.

The AL according to the present embodiment includes the country AL band only, but not limited thereto. However, the AL may further include regional AL information if the telecommunication technologies develop further and the IP addresses are more classified. That is, if the IP address of Korea is included in the AL, various regions of Korea, i.e. Seoul, Pusan, Daegu, and so on may be added to the regional AL.

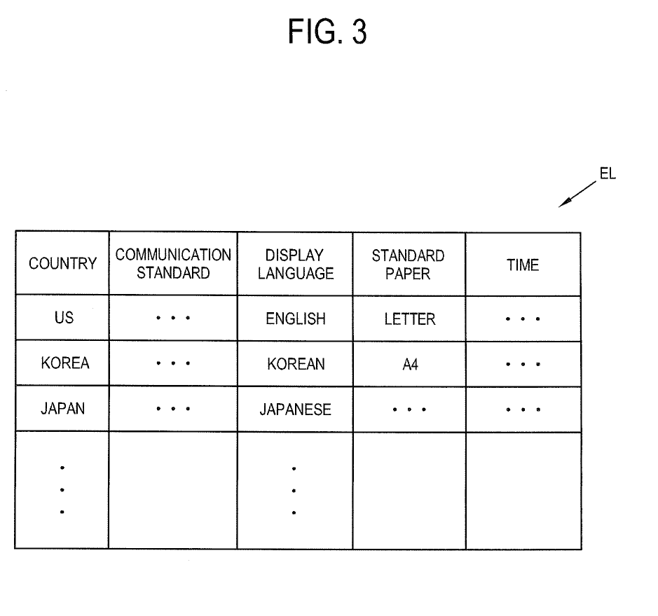

The country environment information list (EL) refers to an environment information assigned to each country. FIG. 3 illustrates an example of the EL. As illustrated therein, the EL may include at least one of a communication standard, a display language, a primary printing medium (paper), and time (time format).

The communication standard is set when the image forming apparatus 100 has the facsimile function, and includes a plurality of items such as a ring count, a ring off time, a dial mode and a redial count. The communication standard varies depending on countries. If the communication standard is set unsuitable for the respective country, fax communication may not be smoothly performed.

The display language refers to a standard language of the respective country. Referring to FIG. 3, the U.S. has English and Korea has Korean as the standard language. The display language is used to display information on the display unit 120. If the standard language corresponding to the respective country is not obvious, a default language may be set such as English.

The standard printing paper refers to the standard of printing paper used in each country. For example, Korea may use A4 while the U.S. may use letter paper as the standard paper. If the standard paper of the respective country is not obvious, the standard paper may be input by a user through the input unit 110 (FIG. 1).

The time refers to local time of each country. The time is set in consideration of time differences between countries. Here, the set time may be displayed on the basis of the time format according to countries.

Referring to FIG. 1, the scanning unit 140 scans documents and generates image data. The scanning unit 140 includes a stage glass (not illustrated) on which a document is put and a scanning head (not illustrated) to move back and forth below the stage glass and to scan an image of the document. The configuration of the scanning unit 140 is the same as that of the conventional image forming apparatus. Thus, a detailed description thereof will be omitted.

The image forming unit 150 forms an image on a printing paper corresponding to the image data generated by the scanning unit 140 or corresponding to the image data received through the communication unit 160. The image forming unit 150 may be classified into an inkjet type, an electrophotographic type and a dye sublimation type depending on an image forming method.

The communication unit 160 retrieves country information through a network. If the image forming apparatus 100 has the facsimile function, the communication unit 160 includes a modem 161 to modulate and demodulate the image data. The modem 161 transmits and receives the image data with respect to another image forming apparatus through a public switching telephone network (PSTN). An NCU is provided between the PSTN and the modem 161 so that the PSTN and the modem 161 interact with each other through the NCU.

The modem 161 modulates the digital image data generated by the scanning unit 140 to generate analog image data, and demodulates the analog image data received from the NCU to generate the digital image data.

Meanwhile, the communication unit 160 may further include a LAN card 163 which receives an IP address from the network. The LAN card 163 accesses an external network so that the image forming apparatus 100 transmits and receives data through the LAN card 163. The image forming apparatus 100 may be connected with an external host device (not illustrated) such as a computer through the LAN card 163 and transmit the image data to/receive the image data from the host device. Here, the LAN card 163 may support wired/wireless communication.

When initially accessing the network, the LAN card 163 receives an IP address of the image forming apparatus 100 through a dynamic host configuration protocol (DHCP) server if the DHCP server is connected to the network. If the DHCP server is not connected to the network accessed by the image forming apparatus 100 or if an operator disconnects the network, the LAN card 163 requests the IP address of the display unit 120 according to a control of the controller 170, and receives the IP address from a user.

If the IP address of the image forming apparatus 100 is automatically set by the DHCP server connected to the network, or set by a user's input through the input unit 110, the LAN card 163 retrieves the information on the country in which the image forming apparatus 100 is used.

The country information may include information such as an IP address, a country name, etc. to identify countries. If the country information includes the country name, the LAN card 163 retrieves web pages or other information through the network to find the name of the country in which the image forming apparatus 100 is used.

If the country information includes the IP address, the LAN card 163 requests the IP address information of the network, and receives the IP address information from a server (not illustrated).

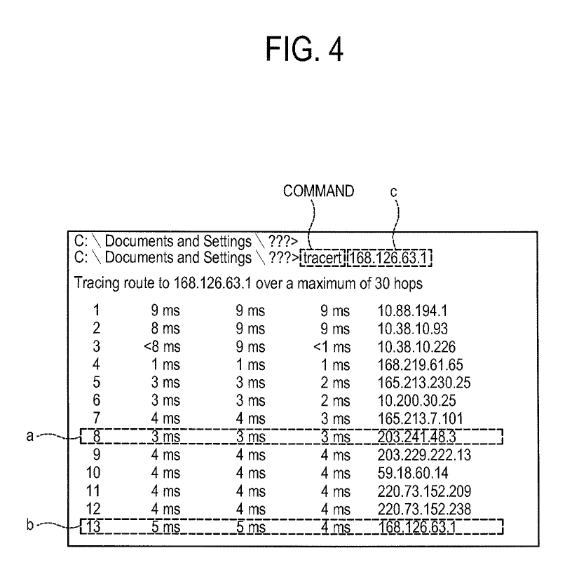

FIG. 4 illustrates an example of retrieving an IP address. As illustrated in FIG. 4, the LAN card 163 receives a command to trace a route by the controller 170, and traces a preset IP address (c) of the image forming apparatus 100 (refer to FIG. 4). The LAN card 163 transmits the IP address information retrieved by the route trace, to the controller 170.

The controller 170 receives the IP address from the LAN card 163, and controls the image forming apparatus 100 to be set with the environment information according to the country corresponding to the received IP address. The controller 170 controls the LAN card 163 to retrieve the IP address of the country in which the image forming apparatus 100 is used through the network if the LAN card 163 is initially connected to the network.

Meanwhile, the controller 170 determines the country concerned by tracing the route of the address retrieved as illustrated in FIG. 4. If the IP address retrieved by the LAN card 163 is received, the controller 170 compares the received IP address with the country AL stored in the storage unit 130 and determines the country having the received IP address.

The controller 170, according to the present embodiment, compares the received IP address with the country AL stored in the storage unit 130, but not limited thereto. If the country AL is not stored in the storage unit 130, the controller 170 may control the communication unit 160 to select the respective country through web pages provided by the network.

If the country is selected corresponding to the IP address compared with the country AL, the controller 170 retrieves the environment information of the country from the country EL. The controller 170 controls to set the environment information of the image forming apparatus according to the retrieved environment information, and controls the image forming apparatus to operate under the set environment information.

If respective regions of the country are different in the environment information, the controller 170 may control the communication unit 160 to retrieve the region of the image forming apparatus 100 and set the environment information according to the retrieved region.

The controller 170 may control the display unit 120 to display the route trace result transmitted by the LAN card 163 and inform a user of the respective route trace result. If the environment information is set according to the address received by the route trace, the display unit 120 displays the set environment information for a user. If the environment information set by the controller 170 is not desired, a user may change the environment information.

The controller 170 may include software such as firmware.

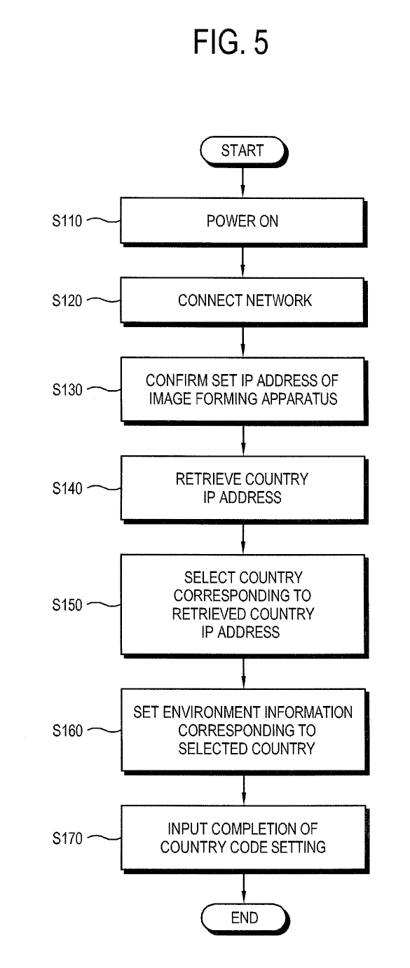

A method of setting the environment information of the image forming apparatus 100 having the foregoing configuration will be described with reference to FIGS. 4 and 5.

Referring to FIGS. 1, 4 and 5, a user turns on the image forming apparatus 100 (operation S110) to connect the LAN card 163 to the network (operation S120). In operation 130, the controller 170 confirms the IP address of the image forming apparatus 100 has been set. In an exemplary embodiment, this can be accomplished, for example, by LAN card 163 determines whether the DHCP server connected to the network operates. If the DHCP server operates, the LAN card 163 requests the I P address of the image forming apparatus 100. If the DHCP server does not operate or is disconnected, the LAN card 163 requests a user to input the IP address (operation S130).

If the IP address of the image forming apparatus 100 is received or input, the controller 170 transmits a command to the LAN card 163 to receive the I P address of the country of the image forming apparatus 100 through the network. Then, the LAN card 163 requests the IP address information of the network (operation S140).

The foregoing processes may be performed as illustrated in FIG. 4. If the LAN card 163 requests the network to trace the standard IP address corresponding to 168.126.63.1 according to the command of the controller 170, an upper IP address of the image forming apparatus 100 is displayed to trace 168.126.63.1(c).

If the LAN card 163 is connected to a company network, the upper IP address may include a gateway, a telecommunication company, a country IP address, etc. 168.126.63.1(b) is the IP address of an internet service provider (ISP) of Korea, and is set during the manufacturing process of the image forming apparatus 100. As the I P address is arbitrarily set for the IP address trace, the IP address may be set by an internet service provider (ISP) of other countries.

The plurality of IP addresses is received as illustrated in FIG. 4 through the LAN card 163 according to the IP address trace with respect to the ISP. The LAN card 163 transmits the received IP address information to the controller 170. The controller 170 compares the received plurality of IP addresses with the country AL stored in the storage unit 130, and selects the corresponding country (operation S150).

For example, referring to FIG. 4, the controller 170 determines that the LAN card 163 is connected to the network of Korea since 203.241.48.3(a) of the received IP addresses is included in the IP address band of Korea.

The controller 170 retrieves the environment information corresponding to Korea from the country environment information list (EL) stored in the storage unit 130 and sets the environment information of the image forming apparatus according to the retrieved environment information (operation Si 50). That is, the controller 170 controls the communication unit 160 to transmit and receive image data according to the communication standard of Korea selected at the operation S150, and controls the display unit 120 to display information in Korean (operation S160). The controller 170 controls the image forming apparatus 100 to operate under the set environment information.

If the environment information setting is completed by the foregoing processes, the controller 170 controls the LAN card 163 not to reset the environment information until a signal is input by a user to reset the environment information (operation S170).

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, various embodiments of the present general inventive concept provides an image forming apparatus to determine a country through IP address retrieval and to set an environment information corresponding to the determined country if connected to a network, and a environment information setting method thereof.

Thus, the image forming apparatus according to various embodiments of the present general inventive concept may enhance user's convenience by reducing a wasteful time delay in setting an environment information for individual countries and improve production efficiency.

Although various exemplary embodiments of the present general inventive concept have been illustrated and described, it will be appreciated by those skilled in the art that changes may be made in these exemplary embodiments without departing from the principles and spirit of the general inventive concept, the scope of which is defined in the appended claims and their equivalents.

What is claimed is:

1. An environment information setting method of an image forming apparatus, the environment information setting method comprising:
connecting the image forming apparatus to a network;
setting an IP (internet protocol) address of the image forming apparatus;
retrieving information on a country in which the image forming apparatus is used through the network; and
setting environment information of the image forming apparatus corresponding to the retrieved country information.

2. The environment information setting method according to claim 1, wherein the country information comprises:
an IP address.

3. The environment information setting method according to claim 2, wherein the image forming apparatus comprises:
a storage unit to store a country IP address list therein.

4. The environment information setting method according to claim 3, further comprising:
comparing the retrieved IP address with the country IP address list and determining the country corresponding to the IP address.

5. The environment information setting method according to claim 1, wherein the retrieving the country information comprises:
retrieving information on a region in which the image forming apparatus is used.

6. The environment information setting method according to claim 2, further comprising:
storing the retrieved country information and the country corresponding to the retrieved country information.

7. The environment information setting method according to claim 1, wherein the environment information comprises:
at least one of a display language, a primary printing medium, and a time format.

8. The environment information setting method according to claim 7, wherein the environment information further comprises:
a communication standard.

9. The environment information setting method according to claim 1, wherein the retrieving the IP address of the country comprises:
tracing a route.

10. The environment information setting method according to claim 9, wherein the setting environment information comprising:
setting the environment information of the image forming apparatus according to the country corresponding to the IP address retrieved by the route tracing.

11. The environment information setting method according to claim 10, further comprising:
displaying at least one of the IP address retrieved by the route tracing and the set environment information.

12. The environment information setting method according to claim 1, wherein the setting the IP address of the image forming apparatus comprises:
setting the IP address through a DHCP (dynamic host configuration protocol) server.

13. The environment information setting method according to claim 1, wherein the setting the IP address of the image forming apparatus comprises:
setting the IP address by a user's input.

14. The environment information setting method according to claim 8, further comprising:
transmitting and receiving fax data under the communication standard.

15. The environment information setting method according to claim 14, further comprising:
printing the received fax data on a printing medium.

16. An image forming apparatus, comprising:
a communication unit to access a network; and
a controller to control the communication unit to retrieve information on a country in which the image forming apparatus is used when the communication unit accesses the network, and sets the environment information of the communication unit according to the country corresponding to the retrieved country information.

17. The image forming apparatus according to claim 15, further comprising a scanning unit to scan a document to generate image data,
a modem to modulate and demodulate the image data and to transmit and to receive the image data, and a local area network (LAN) card which receives the information on the country in which the image forming apparatus is used.

18. The image forming apparatus according to claim 16, wherein the country information comprises:
an IP address.

19. The image forming apparatus according to claim 18, further comprising:
a storage unit to store a country IP address list and a country environment information list, wherein
the controller compares the IP address received through the local area network (LAN) card with the country IP address list to determine the country corresponding to the IP address.

20. The image forming apparatus according to claim 16, wherein the environment information comprises:
at least one of a communication standard, a display language, a standard printing medium and time.

21. The image forming apparatus according to claim 20, wherein the controller controls the display unit to display information with the display language corresponding to the country.

22. An image forming apparatus, comprising:
a communication unit to access a network;
a storage unit to store a country IP address list; and
a controller to control the communication unit to retrieve an internet protocol (IP) address of the image forming apparatus through the network, to determine a respective country corresponding to the retrieved IP address by a comparison of the retrieved IP address with the stored country IP address list, and to set an environment information of the communication unit based on the determined country.

23. A method of setting an environment information in an image forming apparatus, the method comprising:
accessing a network through a communication unit of the image forming apparatus;
controlling the communication unit to retrieve an internet protocol (IP) address of the image forming apparatus through the network to determine a respective country corresponding to the retrieved IP address by a comparison of the retrieved IP address with a country IP address list; and
setting a fax environment of the communication unit based on the determined country.
